(19) United States
(12) Patent Application Publication
(10) Pub. No.: US 2026/0105657 A1
(43) Pub. Date: Apr. 16, 2026

(54) SNAPPING VECTOR OBJECTS TO REFERENCE TRAJECTORIES FOR OBJECT MOVEMENT AND ROTATION

(71) Applicant: Adobe Inc., San Jose, CA (US)

(72) Inventors: Ayushi Gupta, Noida (IN); Shikhar Tayal, ALIGARH (IN); Vivek Agrawal, Noida (IN)

(21) Appl. No.: 18/916,060

(22) Filed: Oct. 15, 2024

(51) Int. Cl. G06T 11/60; G06F 3/0482; G06F 3/04845; G06F 3/04847; G06T 3/60; G06T 7/60

(52) U.S. Cl. CPC G06T 11/60; G06F 3/0482; G06F 3/04845; G06F 3/04847; G06T 3/60; G06T 7/60

(57) ABSTRACT

Methods, systems, and non-transitory computer readable storage media are disclosed for modifying objects in digital images according to reference paths in the digital images. The disclosed system determines, in connection with an object in a vector image, geometric parameters of a pathway of the vector image and a distance from the object to the pathway. The disclosed system also generates, for display via a graphical user interface displaying the vector image, a visual indicator of the geometric parameters of the pathway or the distance from the object to the pathway. The disclosed system modifies, in response to an input via the graphical user interface, a rotation or a position of the object according to the geometric parameters of the pathway or the distance from the object to the pathway.

### BACKGROUND

Vector-based graphics are an important component in many digital graphics environments. Specifically, vector-based graphics provide lossless scaling of images for achieving resolution independence, which is particularly useful in converting digital images to print or in generating different versions of digital content at different resolutions. Although lossless scaling of vector images is critical for many digital image uses, performing certain operations to generate accurate digital image content within vector image spaces is often challenging. For example, editing objects or paths in a vector space and positioning such paths in precise locations is often difficult due to the nature in which vector image data is stored. Conventional image editing systems often lack accuracy and flexibility in editing vector images due to limitations with existing vector editing tools.

### SUMMARY

One or more embodiments provide benefits and/or solve one or more of the foregoing or other problems in the art with systems, methods, and non-transitory computer readable storage media for using reference path geometries in digital vector images to rotate or translate vector objects. For example, the disclosed systems determine candidate paths for editing an object of a vector image by identifying one or more paths within a viewport of a graphical user interface. The disclosed systems determine geometric parameters (e.g., a tangent and a normal) of the candidate paths and distances of the candidate paths to the object. In one or more embodiments, the disclosed systems provide a visual indicator of the geometric parameters of a selected path (i.e., a reference path) and/or the distance from the object to the selected path. In some embodiments, the disclosed systems modify the rotation and/or the position of the object by snapping the object to align with the geometric parameters of the selected path and/or maintaining the distance from the object to the selected path. The disclosed systems thus provide a tool for efficiently and accurately modifying objects to align with selected paths within a digital vector image.

### BRIEF DESCRIPTION OF THE DRAWINGS

Various embodiments will be described and explained with additional specificity and detail through the use of the accompanying drawings.

FIG. 1 illustrates an example system environment in which a path geometry snapping system operates in accordance with one or more implementations.

FIG. 2 illustrates a diagram of an overview of the path geometry snapping system modifying an object to align with a reference path in a vector image in accordance with one or more implementations.

FIG. 3 illustrates a diagram of the path geometry snapping system rotating and/or translating an object in a vector image via geometric parameters of a candidate path and a distance from the candidate path to the object in accordance with one or more implementations.

FIG. 4 illustrates a diagram of the path geometry snapping system snapping an object rotation to align with a tangent or a normal of a reference path in accordance with one or more implementations.

FIG. 5 illustrates a diagram of the path geometry snapping system utilizing an affine transformation matrix to align a translated object with a reference path to maintain one or more offsets in accordance with one or more implementations.

FIGS. 6A-6E illustrate graphical user interfaces for modifying an object according to a reference path in a vector image in accordance with one or more implementations.

FIG. 7 illustrates a diagram of the path geometry snapping system of FIG. 1 in accordance with one or more implementations.

FIG. 8 illustrates a flowchart of a series of acts for modifying an object according to a reference path in a vector image in accordance with one or more implementations.

FIG. 9 illustrates a block diagram of an exemplary computing device in accordance with one or more embodiments.

### DETAILED DESCRIPTION

One or more embodiments of the present disclosure include a path geometry snapping system that modifies an object in a vector image based on one or more reference paths in the vector image. Specifically, the path geometry snapping system identifies candidate paths near an object and selects a candidate path to use as a reference for modifying the object. The path geometry snapping system determines geometric parameters of the selected path and a distance from the object to the selected path. In response to an input to translate or rotate the object, the path geometry snapping system snaps the object rotation and/or position to the selected path according to the geometric parameters and/or the distance. Accordingly, the path geometry snapping system provides fast and easy-to-use tools for aligning objects to existing content in vector images.

As mentioned, in one or more embodiments, the path geometry snapping system identifies candidate paths for using as a reference for modifying an object in a vector image. For example, the path geometry snapping system selects a candidate path by comparing the object's positional or rotational alignment with each candidate path visible in a viewport with the object. Additionally, the path geometry snapping system determines geometric parameters (e.g., a tangent and a normal) of the selected path and a distance from the object to the selected path. In some embodiments, the path geometry snapping system provides tools for snapping the rotation of the object to the tangent or normal or for maintaining an angular or distance alignment with the selected path as the object translates within the vector image (e.g., using an angular offset and/or a linear offset).

In one or more embodiments, the path geometry snapping system provides visual indicators of geometric parameters of a selected path within a graphical user interface displaying a vector image. In particular, in response to identifying one or more candidate paths within a viewport of the vector image, the path geometry snapping system determines a tangent and a normal of each candidate path and a distance from the object to the candidate path. In response to selecting one of the candidate paths as a reference path, the path geometry snapping system generates one or more visual indicators representing the tangent, the normal, and/or the distance for the reference path.

Conventional systems have a number of disadvantages with respect to modifying objects in vector images. Specifically, conventional systems typically provide tools for aligning objects in vector images by snapping the objects to bounding boxes of other content, snapping objects via equidistant measurements of other content, or grid-based alignment. Although such tools provide a variety of ways for users to align and orient objects in vector images, such tools are limited to a narrow set of object editing scenarios. For example, these conventional systems do not take into account certain object or content relationships within vector images, thereby resulting in inflexible vector image editing that limits the types of editing options for objects the vector image space.

Because the conventional systems have limited editing options in the vector image space, the conventional systems also lack accuracy. In particular, generating certain types of content in vector images require adjustment of individual objects via a plurality of separate inputs via a plurality of different editing tools, often leading to difficult and time-consuming editing operations that are also inaccurate. For example, conventional systems that require numerous interactions to adjust anchor points (or corresponding control points) of an object require significant time or expertise to generate certain types of vector image content. Additionally, due to the limited types of snapping methods of conventional systems, vector image content generated using the conventional systems often has imprecise positioning or alignment of different objects. Furthermore, given the limitations of the conventional systems, changes to a single object often require a significant amount of time and excessive user interactions to update other objects (e.g., via modifications to many anchor points) in the vector image to maintain a minimal level of precision in the generated vector image content.

The path geometry snapping system provides a number of advantages over conventional systems in connection with modifying objects in vector images. For example, the path geometry snapping system improves efficiency and accuracy of computing devices via automatically snapping objects to selected path geometries in vector images. In contrast to conventional systems that merely provide tools to modify an object by snapping to bounding boxes or grid-based elements, the path geometry snapping system provides accurate object editing using reference path geometries with few interactions/inputs. In particular, by detecting and visually indicating candidate reference paths within a viewport including the object, the path geometry snapping system provides easy-to-use tools for quickly and accurately aligning different objects in a vector image space.

Furthermore, by determining specific geometric parameters of a reference path and a distance of an object to a reference path, the path geometry snapping system provides tools for accurately orienting and translating objects in vector images relative to other vector image content with improved efficiency. In contrast to conventional systems that provide limited tools for modifying objects in images via many different inputs to achieve imprecise results, the path geometry snapping system provides accurate object editing via the use of one or more reference paths. Specifically, by leveraging geometric attributes of the reference paths and relationships between the reference paths and an object, the path geometry snapping system accurately and efficiently rotates and/or translates the object to preserve various relationships between the object and the reference path(s). The path geometry snapping system also provides flexibility via options to apply individual or combinations of constraints on the position or orientation of an object according to the geometric parameters of a reference path and/or a distance between the object and the reference path.

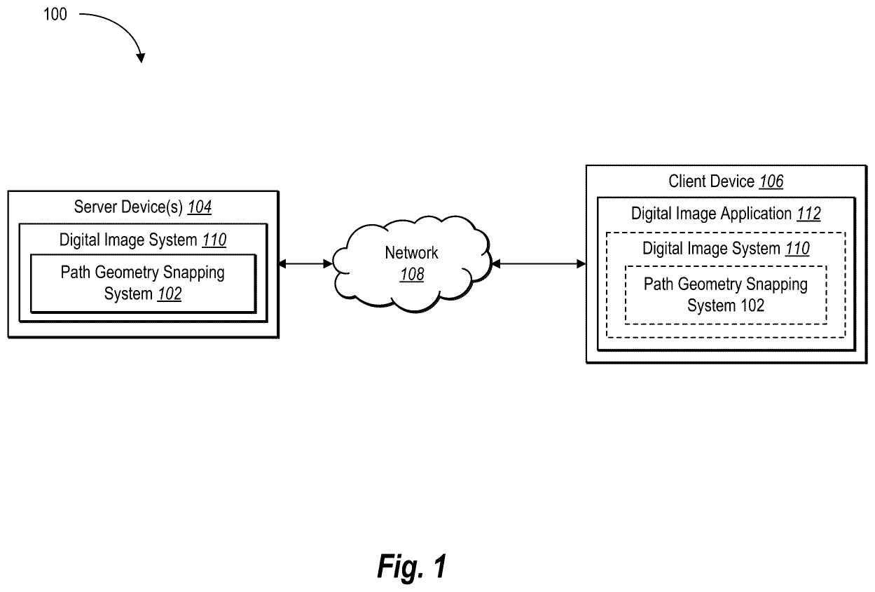

Turning now to the figures, FIG. 1 includes an embodiment of a system environment 100 in which a path geometry snapping system 102 is implemented. In particular, the system environment 100 includes server device(s) 104 and a client device 106 in communication via a network 108. Moreover, as shown, the server device(s) 104 include a digital image system 110, which includes the path geometry snapping system 102. Additionally, the client device 106 includes a digital image application 112, which optionally includes the digital image system 110 and the path geometry snapping system 102.

As shown in FIG. 1, the client device 106 or the server device(s) 104 include or host the digital image system 110. The digital image system 110 includes, or is part of, one or more systems that implement digital image editing operations. For example, the digital image system 110 provides tools for performing various operations on digital images. To illustrate, the digital image system 110 communicates with the client device 106 via the network 108 to provide the tools for display and interaction via the digital image application 112 on the client device 106. Additionally, in some embodiments, the digital image system 110 receives requests to access stored digital images (e.g., at the server device(s) 104 or at another device such as a digital content database) and/or requests to store digital images. In some embodiments, the digital image system 110 receives interaction data for viewing, generating, or editing a digital image (e.g., a digital vector image), processes the interaction data (e.g., to view, generate, or edit a digital image), and provides the results of the interaction data for display via the digital image application 112 or to a third-party system.

According to one or more embodiments, the digital image system 110 utilizes the path geometry snapping system 102 to modify positions or orientations of objects in digital images (e.g., vector images). In particular, in connection with editing digital images, the digital image system 110 utilizes the path geometry snapping system 102 to modify objects within the digital images using reference paths in the digital images (e.g., via the digital image application 112). For example, the path geometry snapping system 102 selects a reference path from candidate paths in a digital image. The path geometry snapping system 102 determines and uses geometric parameters and distance of the reference path to modify the object for modifying the object within the digital image. Thus, the path geometry snapping system 102 snaps the object to align with the reference path in connection with modifying an orientation and/or position of the object.

As illustrated in FIG. 1, in one or more embodiments, the path geometry snapping system 102 is implemented on the client device 106 or on the server device(s) 104. In particular, in some implementations, the path geometry snapping system 102 on the server device(s) 104 supports the path geometry snapping system 102 on the client device 106. For instance, the server device(s) 104 generates or obtains the path geometry snapping system 102 for the client device 106 (e.g., as part of a software application or suite). The server device(s) 104 provides the path geometry snapping system 102 to the client device 106 for performing digital image editing processes on the client device 106. In other words, the client device 106 obtains (e.g., downloads) the path geometry snapping system 102 from the server device(s) 104. At this point, the client device 106 is able to utilize the path geometry snapping system 102 to detect candidate paths and modify objects independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the path geometry snapping system 102 being implemented by a particular component and/or device within the system environment 100, the path geometry snapping system 102 is implemented, in whole or in part, by other computing devices and/or components in the system environment 100. For example, in some embodiments, the server device(s) 104 include or host the digital image system 110 and/or the path geometry snapping system 102.

To illustrate, the path geometry snapping system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to perform digital image editing operations and, in response, the path geometry snapping system 102 or the digital image system 110 on the server device(s) 104 performs operations to modify digital images via automatic path modification operations. The server device(s) 104 provide the output or results of the operations to the client device 106.

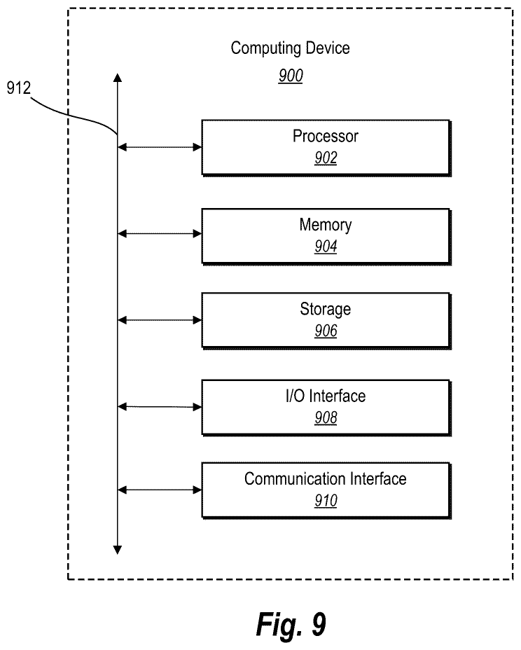

In one or more embodiments, the server device(s) 104 include a variety of computing devices, including those described below with reference to FIG. 9. For example, the server device(s) 104 includes one or more servers for storing and processing data associated with editing digital images. In some embodiments, the server device(s) 104 also include a plurality of computing devices in communication with each other, such as in a distributed storage environment. In some embodiments, the server device(s) 104 include a content server. The server device(s) 104 also optionally includes an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 9). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, and interacting with digital images. In some embodiments, the client device 106 also performs functions for generating, capturing, or accessing data to provide to the digital image system 110 and the path geometry snapping system 102 in connection with editing digital content. For example, the client device 106 communicates with the server device(s) 104 via the network 108 to provide information (e.g., user interactions) associated with digital content. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 9.

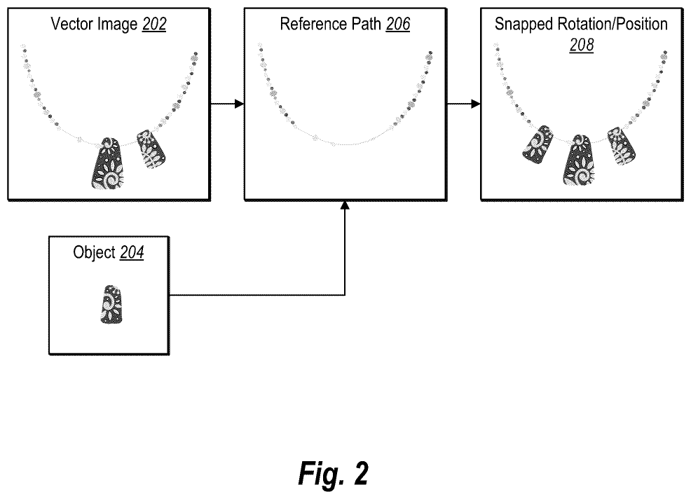

As mentioned, the path geometry snapping system 102 provides tools for modifying a selected object in a digital image via one or more reference paths in the digital image. FIG. 2 illustrates an overview of the path geometry snapping system 102 modifying an object 204 according to a reference path 206 in a vector image 202. In particular, the path geometry snapping system 102 provides various tools for modifying the object 204 in the vector image 202 based on geometries of the reference path 206 and positioning/orientation of the object 204 relative to the reference path 206.

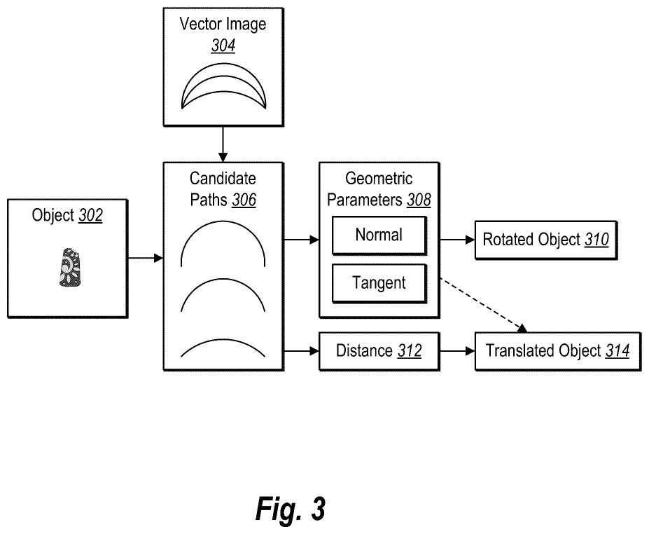

In one or more embodiments, in response to a request to edit an object 204 of the vector image 202, the path geometry snapping system 102 determines the reference path 206 based on one or more existing paths in the vector image 202. For example, the path geometry snapping system 102 determines candidate paths from the existing paths in the vector image 202 (e.g., paths visible in a viewport with the selected object). Specifically, the path geometry snapping system 102 determines the reference path 206 as a path in the vector image 202 that is nearest to a selected object or based on a relationship between the selected object and a particular geometric parameter of the path. For example, the reference path 206 includes a vector path including one or more Bezier curves in a digital image. In some embodiments, the reference path 206 includes a plurality of vector paths connected by one or more anchor points. In alternative embodiments, the reference path 206 includes another type of path such as, but not limited to, a Hermite curve, B-spline, non-uniform rational basis spline, Kappa-curve, or Catmull-Rom spline. FIG. 3 and the corresponding description provide additional detail related to determining candidate paths and selecting a reference path for an object.

As illustrated in FIG. 2, the path geometry snapping system 102 determines geometric parameters of the reference path 206 for use in modifying the object 204 in the vector image 202. In particular, the path geometry snapping system 102 provides tools for snapping the position and/or the orientation of the object 204 based on the reference path 206. For example, the path geometry snapping system 102 determines geometric parameters (e.g., a tangent and/or a normal) of the reference path 206 and a distance between the object 204 and the reference path 206. FIGS. 3-5 and the corresponding description provide additional detail related to determining various relative geometries for an object and a reference path in a vector image.

FIG. 2 illustrates that the path geometry snapping system 102 modifies the object 204 to a snapped rotation/position 208 based on the reference path 206. For example, the path geometry snapping system 102 provides tools for use in rotating and/or translating the object 204 within the vector image 202 while constraining the rotation and/or translation according to the reference path 206. To illustrate, the path geometry snapping system 102 snaps a rotation of the object 204 based on geometric parameters of the reference path 206. Additionally, the path geometry snapping system 102 snaps a position of the object 204 based on the distance between the object 204 and the reference path 206. FIGS. 3-5 and the corresponding description provide additional detail with respect to modifying an object based on a reference path.

FIG. 3 illustrates an example of the path geometry snapping system 102 rotating and/or translating an object 302 within a vector image 304 based on one or more attributes of one or more candidate paths 306 in the vector image 304 in relation to the object. In some embodiments, the path geometry snapping system 102 determines the candidate paths 306 in response to a request to modify a rotation and/or a position of the object 302. For example, in response to receiving an indication of a rotation of the object 302 from the client device 106, the path geometry snapping system 102 determines candidate paths 306 based on various attributes of one or more paths in the vector image 304. To illustrate, the path geometry snapping system 102 determines the candidate paths 306 by identifying paths of the vector image 304 that are visible in a viewport.

In one or more embodiments, the viewport is a bounded area within a graphical user interface that displays a portion of the vector image 304. For example, the viewport includes a display region that dynamically adjusts based on user input received from the client device 106, such as in response to a user input to zoom, pan, or resize the vector image 304. More specifically, the viewport defines the visible boundaries of the surroundings of the object 302 such that paths visible within the viewport are eligible as candidate paths (or within a specific distance of the object 302 within the viewport), while objects or paths outside the visible boundaries are part of the workspace but are not eligible as candidate paths. In additional embodiments, the viewport includes interactive features such as gridlines, snapping guides, or rulers to assist in precise alignment and modification of objects and paths within the visible area.

In one or more embodiments, the path geometry snapping system 102 determines geometric parameters 308 of the candidate paths 306 for use in modifying the object 302. For example, for each of the candidate paths 306, the path geometry snapping system 102 determines a normal and a tangent of a nearest point on the candidate path relative to the object 302. In additional embodiments, the path geometry snapping system 102 also determines a distance 312 from the object 302 to each of the candidate paths 306. For example, the path geometry snapping system 102 determines the distance 312 as a distance from a center point or centroid of the object 302 to the nearest point on a candidate path. In one or more additional examples, the path geometry snapping system 102 determines the distance 312 as a distance from another point of the object 302 (e.g., a point on a particular side of the object 302) to the nearest point on the candidate path.

In one or more embodiments, the path geometry snapping system 102 ranks the candidate paths 306 based on the distance from the object 302 to each of the candidate paths 306 and/or based on an angle of a particular geometric parameter of each candidate path relative to the object 302. Thus, in one or more embodiments, the path geometry snapping system 102 generates a highest ranking for a candidate path closest to the object 302 (or with a lowest angle of a tangent or normal of the candidate path relative to an angle of orientation of the object 302) and a lowest ranking for a candidate path farthest from the object 302 (or with a highest angle of a tangent or normal of the candidate path relative to an angle of orientation of the object 302). Furthermore, as described in more detail below, the path geometry snapping system 102 utilizes the ranking of the candidate paths 306 to select a reference path for use in modifying the orientation and/or position of the object 302 in the vector image 304. In one or more embodiments, the path geometry snapping system 102 also re-ranks the candidate paths 306 in response to a modification to the orientation or position of the object 302 (or to a position of one or more candidate paths) to determine whether to select a new reference path.

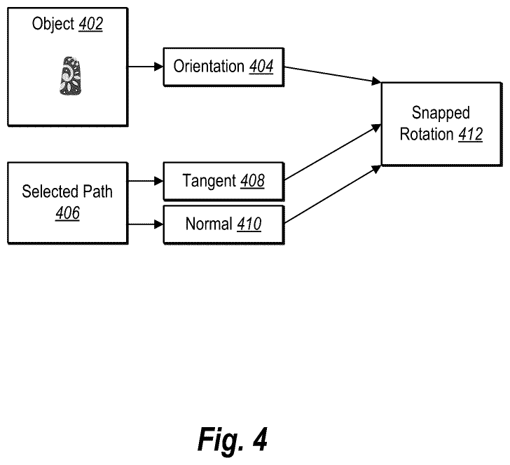

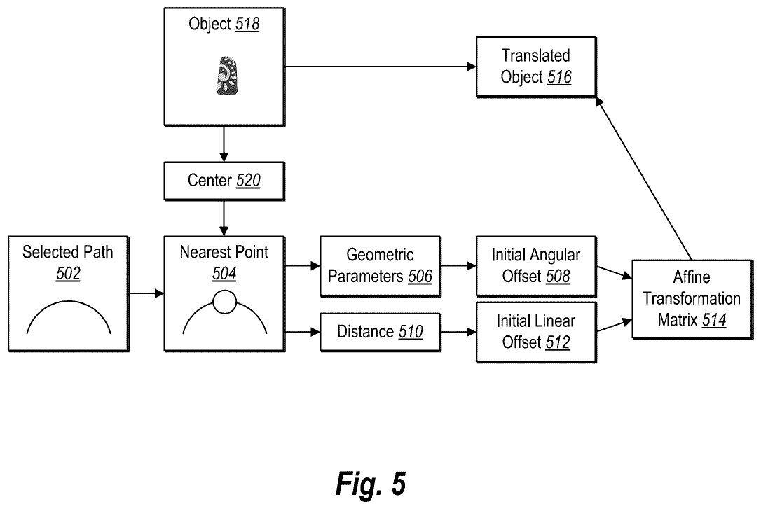

In one or more embodiments, the path geometry snapping system 102 utilizes the geometric parameters 308 and/or distance 312 to perform a modification to the orientation and/or position of the object 302. In particular, as described in relation to FIG. 4, the path geometry snapping system 102 rotates the object 302 to align with geometric parameters 308 of a reference path from the candidate paths 306 in the vector image 304 (e.g., relative to the normal or tangent of a reference path), resulting in a rotated object 310. Additionally, as described in relation to FIG. 5, the path geometry snapping system 102 translates the object 302 based at least on the distance 312 of the reference path from the candidate paths 306 in the vector image 304 to the object 302, resulting in a translated object 314. In some embodiments, the vector image 304 also rotates the object 302 utilizing the geometric parameters 308 in connection with translating the object 302 to maintain a consistent orientation of the object 302 as it moves along the reference path.

As mentioned, in one or more embodiments, the path geometry snapping system 102 selects a reference path from the candidate paths 306 based on one or more geometric parameters of each candidate path and/or distance between the candidate path and the object 302. For example, in response to a request to rotate the object 302, the path geometry snapping system 102 iteratively determines a current rotation angle of the object 302 relative to tangents and normals of the candidate paths 306 to determine the reference path as the candidate path with the tangent or normal with the smallest angle relative to an orientation of the object 302. In one or more embodiments, the path geometry snapping system 102 selects a reference path from the candidate paths 306 based on the distance 312 of each of the candidate paths 306 to the object 302. Specifically, in response to a request to translate the object 302, the path geometry snapping system 102 determines the distances of the candidate paths 306 to the object and selects the closest candidate path as the reference path.

In one or more embodiments, the path geometry snapping system 102 selects or updates the reference path based on one or more thresholds in connection with the geometric parameters 308 and distance 312 of the candidate paths 306. For example, the path geometry snapping system 102 compares an angle between a tangent or normal of a current reference path and the orientation of the object 302 to an angle threshold. In response to determining that the angle exceeds the angle threshold, the path geometry snapping system 102 looks for a new reference path. In one or more embodiments, the path geometry snapping system 102 selects a new reference path having a smallest rotation angle in response to determining that the angle of the current reference path exceeds the angle threshold. In additional embodiments, in response to determining that a distance between the object 302 and a current reference path exceeds a distance threshold, the path geometry snapping system 102 looks for a new reference path and selects the reference path with the lowest distance to the object 302. In one or more embodiments, the path geometry snapping system 102 utilizes a combination of angular and distance thresholds to select the reference path.

As mentioned, in one or more embodiments, the path geometry snapping system 102 generates a rotated object by modifying an object to maintain one or more relationships between the object and various geometric parameters of a reference path and/or a distance between the object and the reference path. FIGS. 4 and 5 provide additional detail with respect to modifying an object based on a reference path. Specifically, the path geometry snapping system 102 performs one or more snapping operations to align the object 302 with the reference path based on the geometric parameters and/or the distance relative to the reference path.

In one or more embodiment, in connection with a request to rotate an object 402, the path geometry snapping system 102 determines an orientation 404 of the object 402. Specifically, the path geometry snapping system 102 determines the orientation 404 based on one or more properties of the object 402 or based on metadata stored for the object 402. For example, some objects in a vector image have stored data indicating an orientation for the object, which the path geometry snapping system 102 accesses to determine the orientation 404. In other examples, the path geometry snapping system 102 determines the orientation 404 based on a distribution of points in the object 402 and their corresponding directionality. In further embodiments, the path geometry snapping system 102 determines the orientation 404 in response to a user-indicated orientation (e.g., based on a drawn orientation or a selected orientation from a plurality of possible orientations).

In addition to determining the orientation 404 of the object 402, the path geometry snapping system 102 also determines a selected path 406 (e.g., a reference path) for rotating the object 402. As mentioned, the path geometry snapping system 102 determines geometric parameters of the selected path 406, including determining a tangent 408 and a normal 410 of the selected path 406. More specifically, the path geometry snapping system 102 determines the tangent 408 and the normal 410 of a point closest to the object 402 (e.g., the center point of the object 402) along the selected path 406. In one or more embodiments, the path geometry snapping system 102 determines the tangent 408 and the normal 410 for use in determining possible orientations for the object 402.

In response to an input to rotate the object 402 using the selected path 406, the path geometry snapping system 102 performs a snapping operation to align the orientation 404 with the tangent 408 or the normal 410 of the selected path 406. For example, the path geometry snapping system 102 snaps the object 302 to align with the tangent 408 or the normal 410 in response to determining that an angle between the orientation 404 and the tangent 408 or the normal 410 satisfies a snapping threshold. In one or more embodiments, a snapping threshold includes a predefined tolerance or range for completing the rotation or position of the object 302 relative to the tangent 408 or the normal 410 of the selected path 406. Thus, in response to the input to rotate the object 402, the path geometry snapping system 102 performs a snapping operation to align the orientation 404 with the tangent 408 or the normal 410 in response to the angle meeting the snapping threshold, resulting in a snapped rotation 412 of the object 402.

In one or more embodiments, after achieving a snapped rotation 412, the path geometry snapping system 102 continues to receive input to rotate the object 402. Accordingly, the path geometry snapping system 102 continually compares the current rotation angle (e.g., based on a position of the input) to the geometric parameters of the selected path 406. In response to determining that the current rotation angle increases to exceed the snapping threshold, the path geometry snapping system 102 unsnaps the orientation 404 with the respective geometric parameter and aligns the orientation 404 with the input until the orientation 404 is within the snapping threshold of another geometric parameter (or another reference path). More specifically, the path geometry snapping system 102 continues to snap the object 402 to align with geometric parameters of one or more candidate paths until the path geometry snapping system 102 determines that the input has stopped rotating the object 402. In some embodiments, the path geometry snapping system 102 sequentially snaps the object 402 to align with candidate paths in descending order based on the distance from the object 402 to the candidate paths until the path geometry snapping system 102 determines that the input has stopped rotating the object 402.

In one or more additional embodiments, in response to the path geometry snapping system 102 detecting a translation of the object 402 before detecting a rotation of the object 402, the path geometry snapping system 102 selects the closest candidate path to the object 402 with matching geometric parameters as the selected path 406. In additional embodiments, in response to the path geometry snapping system 102 determining that none of the candidate paths have matching geometric parameters, the path geometry snapping system 102 selects the candidate path closest to the object 402 as the selected path 406.

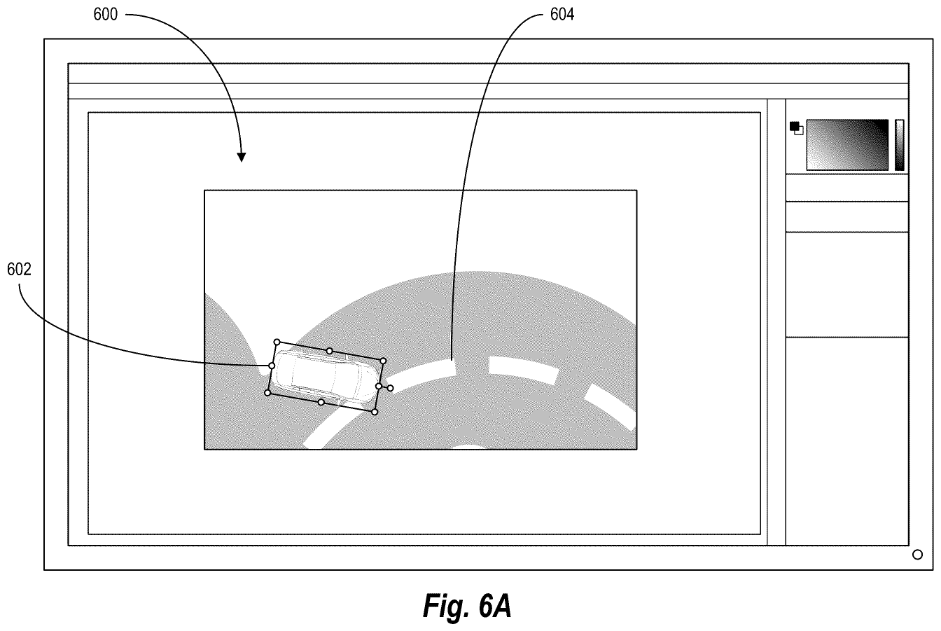

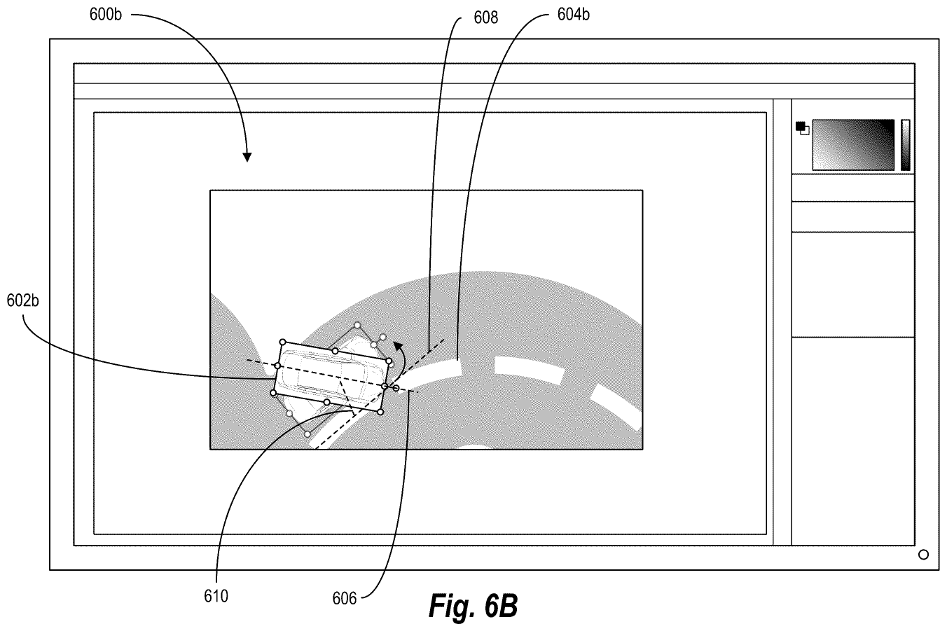

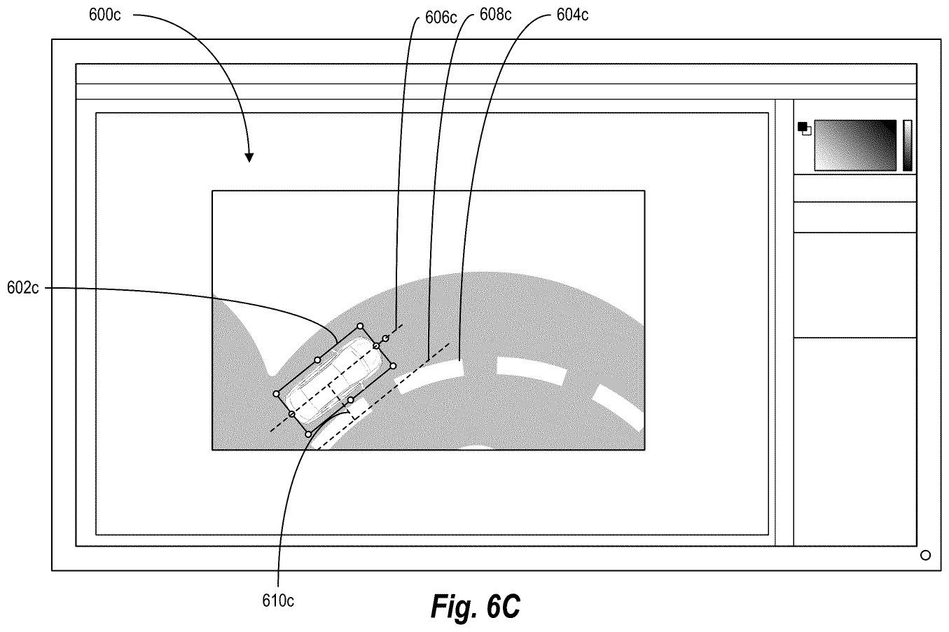

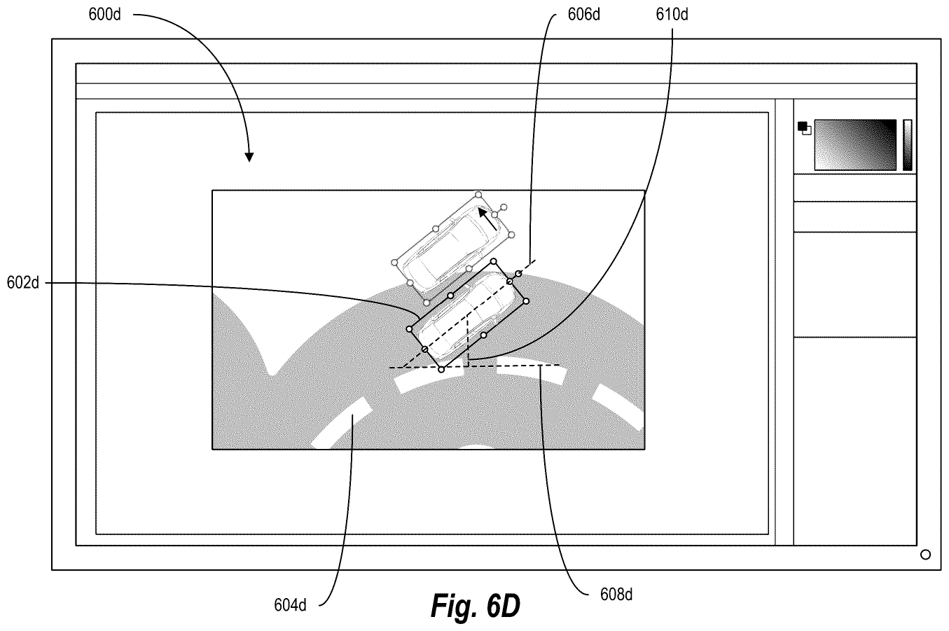

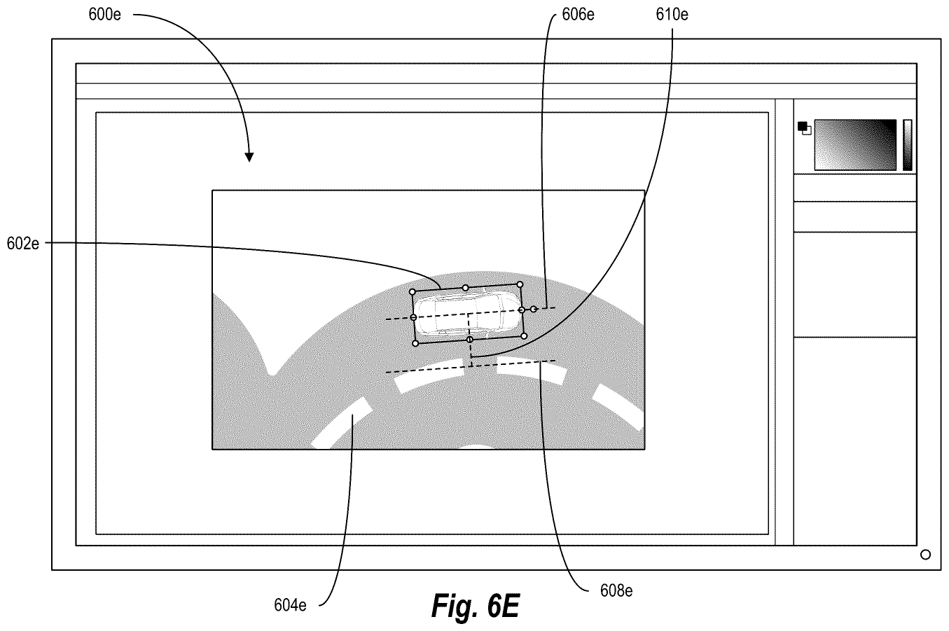

In some embodiments, the path geometry snapping system 102 provides visual indicators of the path geometry snapping system 102 aligning the object 402 with a tangent 408 or normal 410 of a path (e.g., selected path 406). For example, the path geometry snapping system 102 highlights the selected path 406 and/or geometric parameters of the selected path 406. Additionally, in one or more embodiments, the path geometry snapping system 102 indicates the tangent 408, the normal 410, and/or the orientation 404 of the object 402 for providing visual indicators when the path geometry snapping system 102 has snapped the object 402 to align with the selected path 406. FIGS. 6A-6E and the corresponding description provide additional detail related to providing indicators for snapping an object to a reference path.

As mentioned above, in some embodiments, the path geometry snapping system 102 modifies a position and/or an orientation of an object in a vector image to align with a reference path based on various rotation or translation inputs. FIG. 5 illustrates a diagram of the path geometry snapping system 102 utilizing a transformation matrix to rotate and/or translate an object based on a reference path in a vector image. Specifically, the path geometry snapping system 102 utilizes the affine transformation matrix one or more offsets in connection with translating the object in the vector image.

As illustrated in FIG. 5, in response to (or otherwise in connection with) determining a reference path (e.g., selected path 502) for translating an object 518 in a vector image, the path geometry snapping system 102 identifies a center 520 of the object 518 and a nearest point 504 of the selected path 502 relative to the center 520 of the object 518. Additionally, the path geometry snapping system 102 determines geometric parameters 506 of the nearest point 504. For example, the path geometry snapping system 102 determines a tangent and a normal of the nearest point 504. Additionally, in some embodiments, the path geometry snapping system 102 determines a distance 510 from the object 518 to the center 520.

In some embodiments, the path geometry snapping system 102 determines an initial angular offset 508 by determining the angle between an orientation of the object 518 and a tangent or a normal of the nearest point 504. For example, the path geometry snapping system 102 determines a first angle between the orientation of the object 518 and the tangent and a second angle between the orientation of the object 518 and the normal. The path geometry snapping system 102 thus determines the initial angular offset 508 based on either the first angle or the second angle (e.g., the smallest angle or a chosen angle of the first angle and the second angle).

For example, in some cases, the path geometry snapping system 102 calculates the initial angular offset 508 according to the following equation:

$${θ}_{initial \_ offset} = normalized ( {θ}_{abs \_ initial} - {θ}_{tan \_ initial} )$$

where θ_{initial_offset} is the initial angular offset 508. More specifically, θ_{initial_offset} is the difference between the object's current angle θ_{abs_initial} (e.g., the current orientation) and the tangent angle θ_{tan_initial} (e.g., the orientation of the tangent) of a nearest point 504 of the selected path 502. In other embodiments, the path geometry snapping system 102 calculates the initial angular offset 508 based on θ_{abs_initial} and a normal angle θ_{norm_initial}.
In one or more embodiments, the path geometry snapping system 102 normalizes the initial angular offset 508 by adjusting the initial angular offset 508 to fall within a standard range (e.g., [0,2π]). The path geometry snapping system 102 normalizes the initial angular offset 508 according to the following equation:

$${θ}_{initial \_ offset} ∈ [ 0 , 2 π ]$$

where ∈[0,2π] ensures that the initial angular offset 508 is between 0° and 360°.

In additional embodiments, the path geometry snapping system 102 generates an initial linear offset 512 based on the distance 510 between the selected path 502 and the object 518 based on a current position of the object 518. Specifically, the path geometry snapping system 102 calculates the initial linear offset 512 according to the following equation:

$${d}_{initial \_ offset} = cartesian\_distance ( {C}_{initial} , {P}_{initial} )$$

where d_{initial_offset} is the initial linear offset 512. In one or more embodiments, d_{initial_offset} is the difference between the center 520 of the object 518 and the nearest point 504 of the selected path 502. In particular, Cᵢₙᵢₜᵢₐₗ represents the center 520 of the object 518 at the current position of the object 518. Additionally, Pᵢₙᵢₜᵢₐₗ represents the nearest point 504 of the selected path 502 at the current position.

In one or more embodiments, the path geometry snapping system 102 determines the initial angular offset 508 and/or the initial linear offset 512 in response to one or more requests to modify the object 518. For example, the path geometry snapping system 102 determines Cᵢₙᵢₜᵢₐₗ and Pᵢₙᵢₜᵢₐₗ based on the position of the object 518 in response to identifying a request to modify a position of the object 518. The path geometry snapping system 102 thus determines the initial angular offset 508 and the initial linear offset 512 using the values of Cᵢₙᵢₜᵢₐₗ and Pᵢₙᵢₜᵢₐₗ corresponding to the position of the object 518 at the time of the request. The path geometry snapping system 102 uses the initial angular offset 508 and/or the initial linear offset 512 to constrain the object 518 as the object 518 translates according to the request.

As mentioned, the path geometry snapping system 102 generates an affine transformation matrix 514 to maintain the initial angular offset 508 and/or the initial linear offset 512 for the object 518 relative to the selected path 502 as the object translates, resulting in a translated object 516. For example, the path geometry snapping system 102 determines whether to maintain the initial angular offset 508 and/or the initial linear offset 512 based on the request. To illustrate, the request includes an indication to maintain one or more of the offsets based on a selection of a specific tool in a digital image editing application or a selection of one or more specific modifier keys/inputs during translation of the object 518.

In one or more embodiments, to maintain the initial angular offset 508 in response to detecting a translation of the object 518, the path geometry snapping system 102 rotates the object 518 from the center 520 to maintain the difference between the orientation of the object 518 and the selected path 502. More specifically, the path geometry snapping system 102 iteratively updates the nearest point 504 on the selected path 502 relative to the current position of the object 518 and determines the tangent and the normal of the nearest point 504 as updated. Accordingly, the path geometry snapping system 102 maintains the initial angular offset 508 by adjusting the orientation based on the tangent or the normal of the nearest point 504 as the nearest point 504 changes.

In one or more embodiments, in response to detecting a translation of the object 518, the path geometry snapping system 102 translates the object 518 to maintain the distance 510 from the center 520 of the object 518 to the nearest point 504 of the selected path 502 (as the nearest point 504 changes) to maintain the initial linear offset 512. Specifically, the path geometry snapping system 102 utilizes an affine transformation matrix 514 involving a delta translation to adjust the center 520 of the object 518. For example, the path geometry snapping system 102 recalculates the nearest point 504 of the selected path 502 to the center 520 of the object 518 as the position of the object 518 changes. In connection with the changing position of the object 518, the path geometry snapping system 102 translates the object 518 so that the distance between current center position of the object 518 and the current nearest point of the selected path 502 is the same as the distance 510 according to the initial linear offset 512. In particular, the path geometry snapping system 102 generates the affine transformation matrix 514 in two-dimensional space:

$$[ T ] = [ \begin{matrix}a & b & {t}_{x} \\ c & d & {t}_{y} \\ 0 & 0 & 1\end{matrix} ]$$

where [T] is the affine transformation matrix 514. Here, a and d represent scaling, b and c represent shear and rotation, and t, and ty represent translation.

The overall translation matrix [T_{stage}_{₁}] is represented by the equation:

$$[ {T}_{{stage}_{1}} ] = [ {T}_{current} ] \cdot [ {T}_{linear \_ offset} ]$$

where [T_{current}] represents a current translation matrix based on input (e.g., cursor or slider element) movement on a client device (e.g., client device 106). For example, the current translation matrix [T_{current}] reflects the current position of the object 518. [T_{linear_offset}] is a delta translation matrix that the path geometry snapping system 102 uses to adjust the position of the object 518 to maintain the initial linear offset 512. The path geometry snapping system 102 calculates the overall translation matrix [T_{stage}_{₁}] by multiplying the current translation matrix [T_{current}] by the delta translation matrix T_{linear_offset}. Thus, the path geometry snapping system 102 uses the translation matrix [T_{stage}_{₁}] to translate the object 518 to a new position while preserving the initial linear offset 512 of the object 518 to the selected path 502.

To elaborate, [T_{linear_offset}] is represented as:

$$[ {T}_{linear \_ offset} ] = [ \begin{matrix}1 & 0 & {C}_{new \_ x} - {C}_{translated \_ x} \\ 0 & 1 & {C}_{new \_ y} - {C}_{translated \_ y} \\ 0 & 0 & 1\end{matrix} ]$$

where C_{new_x}−C_{translated_x} represents translation along the x-axis and C_{new_y}−C_{translated_y} represents translation along the y-axis.

According to one or more embodiments, the path geometry snapping system 102 maintains the initial angular offset 508 relative to a tangent of the nearest point 504 (as the nearest point 504 changes) according to the following equations:

$${θ}_{abs \_ new} = normalized ( {θ}_{tan \_ new} + {θ}_{initial \_ offset} )$$

$${θ}_{delta} = normalized ( {θ}_{abs \_ curr} - {θ}_{abs \_ new} )$$

$${θ}_{abs \_ new} , {θ}_{delta} ∈ [ 0 , 2 π ]$$

where θ_{abs_new} is the new absolute rotation angle (e.g., the new angle of the object orientation) for the object 518. For example, the new absolute rotation indicates the orientation of the object 518 after the path geometry snapping system 102 has snapped the object 518 to align with the selected path 502. θ_{tan_new} is the new tangent angle of the current nearest point of the selected path 502 to the object 518. For example, the path geometry snapping system 102 determines the new tangent angle θ_{tan_new} in response to detecting a translation of the object 518 relative to the selected path 502. The path geometry snapping system 102 calculates the new absolute rotation angle θ_{abs_new} of the object 518 by adding the initial angular offset 508 to the new tangent angle θ_{tan_new}. In one or more embodiments, the path geometry snapping system 102 performs similar operations to maintain the initial angular offset 508 for a normal angle.

In one or more embodiments, θ_{delta} is the difference (i.e., the delta rotation) between the current absolute rotation angle θ_{abs_curr} of the object 518 and the new absolute angle θ_{abs_new}. θ_{abs_curr} is the absolute angle of the object 518 before the object 518 is rotated and/or translated. Similar to above, the path geometry snapping system 102 ensures that the delta rotation θ_{delta} and the new absolute angle θ_{abs_new} are within the standard range of [0,2π].

In some embodiments, the path geometry snapping system 102 utilizes the affine transformation matrix 514 to rotate the object 518 by computing an affine rotation matrix for the delta rotation angle about C_{new}, representing the new center point position, and concatenating with the transformation matrix via the equation:

$$[ {T}_{{stage}_{2}} ] = [ {T}_{stage \_ 1} ] \cdot [ {T}_{rotation \_ offset} ]$$

where [T_{stage}_{₂}] is the final transformation matrix and the product of the transformation matrix [T_{stage_1}] and a rotation offset matrix [T_{rotation_offset}]. The final transformation matrix [T_{stage}_{₂}] ensures that both the initial angular offset 508 and the initial linear offset 512 of the object 518 to the selected path 502 are maintained by applying angular and linear transformations to the object 518 during translation of the object 518

The path geometry snapping system 102 determines the rotation offset matrix [T_{rotation_offset}] according to the following equation:

$$[ {T}_{rotation \_ offset} ] = [ {T}_{{C}_{new}} ] \cdot [ {T}_{delta \_ rotation} ] \cdot [ {T}_{{C}_{new}}^{-} ]$$

where the rotation offset [T_{rotation_offset}] represents the rotation transformation applied to the object 518 around the point C_{new}, which is the adjusted center of the object 518 after translation. [T_{C}_{_{new}}] is a translation matrix that the path geometry snapping system 102 uses to move the origin of the coordinate system to the new center point C_{new}, which the path geometry snapping system 102 uses to center the rotation of the object 518. T⁻C_{new} is the inverse of the translation matrix [T_{C}_{_{new}}] and translates the origin back from C_{new} to the original center of the coordinate system.

In one or more embodiments, [T_{delta_rotation}] is a delta rotation matrix that the path geometry snapping system 102 utilizes to rotate the object 518:

$$[ {T}_{delta \_ rotation} ] = [ \begin{matrix}cos ( {θ}_{delta} ) & - sin ( {θ}_{delta} ) & 0 \\ sin ( {θ}_{delta} ) & cos ( {θ}_{delta} ) & 0 \\ 0 & 0 & 1\end{matrix} ]$$

which the path geometry snapping system 102 uses to achieve angular movement of θ_{delta}.

In some embodiments, as mentioned, the path geometry snapping system 102 utilizes modifier keys to maintain the initial angular offset 508 and/or the initial linear offset 512 between the object 518 and the selected path 502. For example, the path geometry snapping system 102 only maintains the initial angular offset 508 or the initial linear offset 512 of the object 518 in response to an indication of a selection of a first modifier key or a second modifier key from a client device (e.g., client device 106 of FIG. 1). Additionally, in one or more embodiments, the path geometry snapping system 102 maintains both the initial angular offset 508 and the initial linear offset 512 in response to an indication of a selection of both a first modifier key and a second modifier key from the client device (or in response to an indication of a selection of a third modifier key).

In one or more embodiments, as mentioned, the path geometry snapping system 102 provides visual indicators of an object snapping to align with a selected path. FIGS. 6A-6E provide graphical user interfaces of client devices for constraining a rotation or translation of an object based on a reference path. Additionally, FIGS. 6A-6E illustrate various indicators associated with modifying an object based on a reference path in a digital image.

FIG. 6A illustrates that a client device displays a digital image including an artwork 600. As illustrated, the artwork 600 includes an object 602 and a path 604. In one or more embodiments, the path geometry snapping system 102 identifies the object 602 within the artwork 600 in connection with a request to modify the object 602. Additionally, in one or more embodiments, the path geometry snapping system 102 selects the path 604 to use as a reference path for modifying the object 602. In one or more embodiments, as previously described, the path geometry snapping system 102 selects the path 604 as the reference path based on one or more candidate paths in a viewport of the graphical user interface (e.g., according to a distance between the object 602 and the path 604 and/or one or more geometric parameters of the path 604).

FIG. 6B illustrates that the client device displays the digital image including a modified artwork 600b. In particular, the path geometry snapping system 102 modifies the artwork 600 of FIG. 6A to generate the modified artwork 600b in response to a request to modify object 602b (e.g., via a rotation operation). For instance, in response to an input to rotate the object 602b, the path geometry snapping system 102 generates a visual indicator 606 of an orientation of the object 602b.

Additionally, in some embodiments, the path geometry snapping system 102 generates a visual indicator 608 of a tangent of a nearest point of the reference path 604b to the object 602b. To illustrate, the path geometry snapping system 102 generates the visual indicator 606 in response to an angle of an orientation of the object 602b being within a threshold of the tangent. In alternative embodiments, the path geometry snapping system 102 generates a visual indicator of the normal of the nearest point of the reference path 604b or a plurality of indicators for the tangent and the normal of the nearest point of the reference path 604b. In additional embodiments, the path geometry snapping system 102 generates a visual indicator 610 of the distance from a nearest point of the selected path to the center of the object 602b.

FIG. 6C illustrates that the client device displays a modified artwork 600c in response to the path geometry snapping system 102 modifying an object 602c. For example, in response to determining that the orientation of the object 602c satisfies a snapping threshold relative to the tangent of the nearest point on the selected path 604c, the path geometry snapping system 102 snaps the object 602c to align a visual indicator 606c of the orientation of the object 602c with a visual indicator 608c of the tangent of the nearest point on selected path 604c. To illustrate, the path geometry snapping system 102 snaps the orientation of the object 602c to the tangent of the selected path 604c by reducing an angle of difference between the orientation and the tangent to zero. As illustrated, in one or more embodiments, the path geometry snapping system 102 also displays a visual indicator 610c of the distance between the center of the object 602c and the selected path 604c to indicate that the distance did not change. In additional embodiments, the path geometry snapping system 102 provides object snapping based on a normal of the nearest point of the selected path 604c.

FIG. 6D illustrates that the client device displays a modified artwork 600d in response to the path geometry snapping system 102 translating an object 602d while maintaining a linear offset of the object 602d relative to a selected path 604d. Specifically, in one or more embodiments, the path geometry snapping system 102 determines a position of a cursor or other input translating the object 602d. In connection with translating the object 602d, the path geometry snapping system 102 maintains an initial linear offset of the object 602d relative to the selected path 604d. To illustrate, the path geometry snapping system 102 determines the initial linear offset based on the initial distance between the object 602d and the selected path 604d (e.g., as illustrated in FIG. 6C).

Additionally, in some embodiments, the input to translate the object 602d includes a slider element. Specifically, the path geometry snapping system 102 determines a position of the object 602d along the selected path 604d based on a position of a slider element displayed in the graphical user interface. Thus, in response to a modification of the slider element, the path geometry snapping system 102 modifies the position of the object 602d relative to the selected path 604d (e.g., as a proportional distance along the selected path 604d based on the moved distance of the slider). To illustrate, a position of 0 on the slider element corresponds to a first end of the selected path 604d and a position of 100 on the slider element corresponds to a second end of the selected path 604d. In additional embodiments, the input includes a text box that allows values from 0 to 100.

For example, in response to determining the position of a cursor translating the object 602d (e.g., as illustrated in FIG. 6D), the path geometry snapping system 102 translates the object 602d in the direction of the current nearest point of the selected path 604d to maintain the initial linear offset from the center of the object 602d to the current nearest point of the selected path 604d. Thus, rather than placing the object 602d at the position of the cursor, the path geometry snapping system 102 slides the object 602d along the selected path 604d such that the distance between the object 602d and the selected path 604d is the same at each new translation position. In one or more embodiments, the client device also displays a visual indicator 610d illustrating that the distance from the center of the object 602d to the current nearest point of the selected path 604d is equal to the distance from the object 602c to the nearest point of the selected path 604c in FIG. 6C. Furthermore, as illustrated, the visual indicator 606d of the orientation of the object 602d indicates that the object 602d orientation stays the same during translation such that the orientation is no longer aligned with the tangent of the selected path 604d, as shown by the visual indicator 608d of the tangent.

FIG. 6E illustrates that the client device displays a modified artwork 600e in response to the path geometry snapping system 102 translating an object 602e while maintaining a linear offset and an angular offset relative to a selected path 604e. In connection with translating the object 602e, the path geometry snapping system 102 maintains an initial linear offset and an initial angular offset of the object 602e relative to the selected path 604e. To illustrate, the path geometry snapping system 102 determines the initial linear offset based on the initial distance between the object 602e and the selected path 604e (e.g., as illustrated in FIG. 6C). Additionally, the path geometry snapping system 102 determines the initial angular offset based on the angle difference between the orientation of the object 602e and the tangent of the selected path 604e (e.g., after snapping the rotation of the object to the tangent of the selected path as in FIG. 6C).

In one or more embodiments, the path geometry snapping system 102 translates and rotates the object 602e based on a cursor position moving the object 602e along the selected path 604e to maintain the initial linear offset and initial angular offset. For example, the path geometry snapping system 102 continually updates the nearest point of the selected path 604e to the object 602e as the object 602e translates and adjusts the position and orientation of the object 602e to maintain the offsets. In one or more embodiments, as illustrated, the client device displays a visual indicator 606e of the orientation of the object 602e and a visual indicator 608e of the tangent of the nearest point of the selected path 604e indicating that the orientation aligns with the tangent according to the initial angular offset. Additionally, as illustrated, the client device displays a visual indicator 610e of the distance from the center of the object 602e to the nearest point of the selected path 604e, indicating that the distance corresponds to the initial linear offset. As illustrated in FIGS. 6A-6E, the path geometry snapping system 102 thus provides tools for modifying objects (e.g., position and/or orientation) and/or artworks in a digital image and for providing visual indicators of objects snapping to align with reference paths.

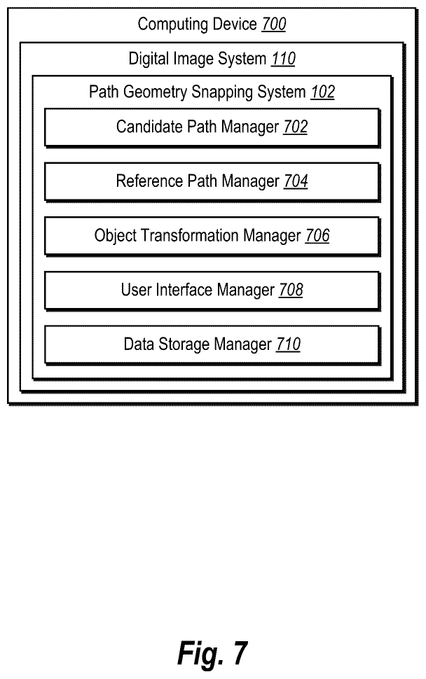

FIG. 7 illustrates a detailed schematic diagram of an embodiment of the path geometry snapping system 102 described above. As shown, the path geometry snapping system 102 is implemented in a digital image system 110 on computing device 700 (e.g., a client device and/or server device as described in FIG. 1, and as further described below in relation to FIG. 9). Additionally, the path geometry snapping system 102 includes, but is not limited to, a candidate path manager 702, a reference path manager 704, an object transformation manager 706, a user interface manager 708, and a data storage manager 710. In one or more embodiments, the path geometry snapping system 102 is implemented on any number of computing devices. For example, path geometry snapping system 102 is implemented in a distributed system of server devices for digital images. In one or more embodiments, the path geometry snapping system 102 is implemented within one or more additional systems. Alternatively, the path geometry snapping system 102 is implemented on a single computing device such as a single client device.

In one or more embodiments, each of the components of the path geometry snapping system 102 is in communication with other components using any suitable communication technologies. Additionally, the components of the path geometry snapping system 102 are capable of being in communication with one or more other devices including other computing devices of a user, server devices (e.g., cloud storage devices), licensing servers, or other devices/systems. It will be recognized that although the components of the path geometry snapping system 102 are shown to be separate in FIG. 7, in various embodiments, any of the subcomponents are combined into fewer components, such as into a single component, or divided into more components as serves a particular implementation. Furthermore, although the components of FIG. 7 are described in connection with the path geometry snapping system 102, in some embodiments, at least some of the components for performing operations in conjunction with the path geometry snapping system 102 described herein are implemented on other devices within the environment.

In some embodiments, the components of the path geometry snapping system 102 include software, hardware, or both. For example, the components of the path geometry snapping system 102 include one or more instructions stored on a computer-readable storage medium and executable by processors of one or more computing devices (e.g., the computing device 700). When executed by the one or more processors, the computer-executable instructions of the path geometry snapping system 102 cause the computing device 700 to perform the operations described herein. Alternatively, the components of the path geometry snapping system 102 include hardware, such as a special purpose processing device to perform a certain function or group of functions. Additionally, or alternatively, the components of the path geometry snapping system 102 include a combination of computer-executable instructions and hardware.

Furthermore, the components of the path geometry snapping system 102 performing the functions described herein with respect to the path geometry snapping system 102 are, for example, implemented as part of a stand-alone application, as a module of an application, as a plug-in for applications, as a library function or functions that may be called by other applications, and/or as a cloud-computing model. Thus, the components of the path geometry snapping system 102 are implemented as part of a stand-alone application on a personal computing device or a mobile device. Alternatively, or additionally, the components of the path geometry snapping system 102 are implemented in any application that provides digital image modification, including, but not limited to ADOBE® ILLUSTRATOR® and ADOBE® CREATIVE CLOUD® software.

As illustrated, the path geometry snapping system 102 includes a candidate path manager 702 to determine one or more candidate paths (e.g., paths visible in a viewport) of a digital image for modifying a selected object. For instance, the candidate path manager 702 determines and stores geometric parameters of each candidate path and/or a distance from each candidate path to the selected object. Additionally, the candidate path manager 702 ranks candidate paths based on the distance of each candidate path to the selected object and/or relationships between the orientation of the selected object to geometric parameters of each candidate path.

In one or more embodiments, the path geometry snapping system 102 includes a reference path manager 704 to select a reference path from one or more candidate paths. For example, the reference path manager 704 compares a rotation angle (e.g., an orientation) of a selected object to geometric parameters of the one or more candidate paths to select a reference path. In additional examples, the reference path manager 704 compares a distance of the selected object to each of the candidate paths to select a reference path.

The path geometry snapping system 102 also includes an object transformation manager 706 to modify an object based on a reference path. For example, the object transformation manager 706 uses distance information and/or geometric parameter information to translate and/or rotate an object to align with a reference path. In additional embodiments, the object transformation manager 706 translates an object to maintain one or more offsets between the object and the reference path.

The path geometry snapping system 102 also includes a user interface manager 708 to provide tools and information associated with modifying objects in a digital image. The user interface manager 708 also provides tools for selecting or otherwise interacting with paths in the digital image. The user interface manager 708 also provides visual indicators of candidate paths visible in a viewport of a digital image including a selected object.

The path geometry snapping system 102 also includes a data storage manager 710 (that comprises a non-transitory computer memory) that stores and maintains data associated with modifying objects based on reference paths in digital images. For example, the data storage manager 710 stores geometric parameters (e.g., tangents and normals) of paths, orientations of objects, and distances between objects and paths. The data storage manager 710 also stores linear offsets, angular offsets, and transformation matrices associated with modifying an object based on a reference path.

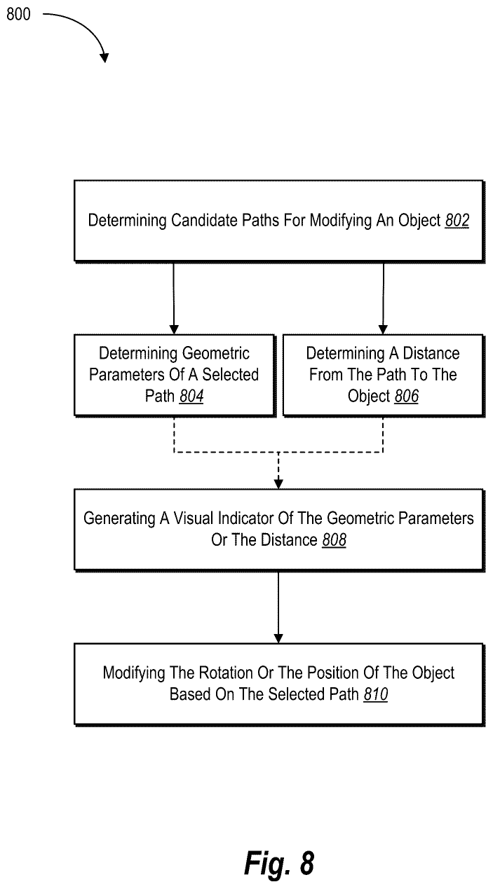

Turning now to FIG. 8, this figure shows a flowchart of a series of acts 800 of modifying an object according to one or more reference paths in a digital image. While FIG. 8 illustrates acts according to one embodiment, alternative embodiments may omit, add to, reorder, and/or modify any of the acts shown in FIG. 8. The acts of FIG. 8 are part of a method. Alternatively, a non-transitory computer readable medium comprises instructions, that when executed by one or more processors, cause the one or more processors to perform the acts of FIG. 8. In still further embodiments, a system includes a processor or server configured to perform the acts of FIG. 8.

As shown, the series of acts 800 includes an act 802 of determining candidate paths for modifying an object. The series of acts 800 also include an act 804 of determining geometric parameters of a selected path. Furthermore, the series of acts 800 includes an act 806 of determining a distance from the path to the object. Additionally, the series of acts 800 includes an act 808 of generating a visual indicator of the geometric parameters or the distance from the path to the object. The series of acts 800 also includes an act 810 of modifying the rotation or the position of the object based on the selected path.

In one or more embodiments, act 802 involves determining, for an object in a vector image, one or more candidate pathways of the vector image. Act 804 and act 806 involve determining geometric parameters of a selected pathway of the one or more candidate pathways and a distance from the object to the selected pathway. Act 808 involves generating, for display via a graphical user interface displaying the vector image, a visual indicator of the geometric parameters of the selected pathway or the distance from the object to the selected pathway. Act 810 involves modifying, in response to an input via the graphical user interface, a rotation or a position of the object according to the geometric parameters of the selected pathway or the distance from the object to the selected pathway.

In one or more embodiments, the series of acts 800 includes determining, in response to the input comprising a rotation of the object, the one or more candidate pathways of the vector image within a viewport of the graphical user interface. The series of acts 800 includes generating a ranked list of the one or more candidate pathways based on distances between a center of the object and nearest points of the one or more candidate pathways. The series of acts 800 further includes determining that the selected pathway is closest to the center of the object from the ranked list of the one or more candidate pathways.

In one or more embodiments, the series of acts 800 includes determining a tangent and a normal of a point of the selected pathway. The series of acts 800 also includes determining an initial angular offset between a portion of the object and the tangent or the normal of the point of the selected pathway. The series of acts 800 also includes determining an initial linear offset between the center of the object and the selected pathway, the initial linear offset corresponding to the distance from the object to the selected pathway.

In one or more embodiments, the series of acts 800 includes determining that the input comprises a translation of the object. The series of acts 800 further includes determining a nearest point of the selected pathway based on the center of the object. The series of acts 800 also includes modifying the rotation of the object to maintain the initial angular offset for the object relative to an additional tangent or an additional normal of the nearest point of the selected pathway utilizing a translation matrix.

In one or more embodiments, the series of acts 800 includes modifying, in response to the translation of the object, the position of the object to maintain the initial linear offset for the object relative to the nearest point of the selected pathway.

In one or more embodiments, the series of acts 800 includes determining a tangent and a normal of a point of the selected pathway. The series of acts 800 also includes snapping an orientation of the object to the tangent or the normal of the point of the selected pathway in response to the input via the graphical user interface.

In one or more embodiments, the series of acts 800 includes determining, by at least one processor in connection with an object in a vector image, geometric parameters of a pathway of the vector image and a distance from the object to the pathway. The series of acts 800 further includes generating, by the at least one processor and for display via a graphical user interface displaying the vector image, a visual indicator of the geometric parameters of the pathway or the distance from the object to the pathway. Additionally, the series of acts 800 includes modifying, by the at least one processor in response to an input via the graphical user interface, a rotation or a position of the object according to the geometric parameters of the pathway or the distance from the object to the pathway.

According to one or more embodiments, the series of acts 800 includes generating an indication of a tangent or a normal of a point of the pathway based on the position of the object. Additionally, the series of acts 800 includes determining an initial angular offset between a portion of the object and the tangent or the normal of the point of the pathway. The series of acts 800 further includes rotating, in response to the input via the graphical user interface, the object to maintain the initial angular offset between the portion of the object and the tangent or the normal of the pathway as the position of the object changes in the vector image.

In one or more embodiments, the series of acts 800 includes determining an initial linear offset between a portion of the object and the pathway based on the distance from the object to the pathway. The series of acts 800 also includes modifying the position of the object in the vector image to maintain the initial linear offset between the portion of the object and the pathway. Additionally, the series of acts 800 includes generating, for display via the graphical user interface, a visual indication of the initial linear offset as the position of the object changes.

In one or more embodiments, the series of acts 800 includes determining that the input via the graphical user interface comprises an input modifier. The series of acts 800 also includes modifying, in response to the input modifier, the rotation or the position of the object according to the geometric parameters of the pathway or the distance from the object to the pathway.

In one or more embodiments, the series of acts 800 includes providing, for display via the graphical user interface, a slider element that controls a translation of the object along the pathway. The series of acts 800 further includes modifying the position of the object along the pathway in response to the input via the graphical user interface modifying the slider element.

In one or more embodiments, the series of acts 800 includes determining a plurality of candidate pathways of the vector image within a viewport of the graphical user interface. The series of acts 800 also includes selecting the pathway from the plurality of candidate pathways in response to determining that the pathway is closest to the object.

In one or more embodiments, the series of acts 800 includes determining, in response to a selection of an object in the vector image, one or more candidate pathways of the vector image within a viewport of a graphical user interface displaying the vector image. The series of acts 800 also includes determining geometric parameters of a selected pathway of the one or more candidate pathways and a distance from the object to the selected pathway. The series of acts 800 also includes modifying, in response to an input via the graphical user interface, a rotation or a position of the object according to the geometric parameters of the selected pathway or the distance from the object to the selected pathway.

In one or more embodiments, the series of acts 800 includes determining the one or more candidate pathways further by generating a ranked list including the one or more candidate pathways in order based on a distance of the one or more candidate pathways to the object. The series of acts 800 includes determining the selected pathway by selecting a pathway with a highest ranking from the ranked list. Additionally, the series of acts 800 includes determining an initial linear offset based on the distance from a center of the object to the selected pathway. Furthermore, the series of acts 800 includes determining an initial angular offset between the object and the selected pathway based on the geometric parameters of the selected pathway and an orientation extracted from metadata of the object.

In one or more embodiments, the series of acts 800 includes rotating, in response to the input changing the position of the object within the vector image, the object to maintain the initial angular offset between the orientation of the object and the selected pathway. In one or more embodiments, the series of acts 800 includes translating the object along the selected pathway while maintaining the initial linear offset between the center of the object and points of the selected pathway nearest to the center of the object.

In one or more embodiments, the series of acts 800 includes determining, from the selected pathway, a point closest to the object. The series of acts 800 also includes determining a tangent and a normal of the point closest to the object.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 that may be configured to perform one or more of the processes described above. One will appreciate that one or more computing devices such as the computing device 900 may implement the system(s) of FIG. 1. As shown by FIG. 9, the computing device 900 can comprise a processor 902, a memory 904, a storage device 906, an I/O interface 908, and a communication interface 910, which may be communicatively coupled by way of a communication infrastructure 912. In certain embodiments, the computing device 900 can include fewer or more components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions for dynamically modifying workflows, the processor 902 may retrieve (or fetch) the instructions from an internal register, an internal cache, the memory 904, or the storage device 906 and decode and execute them. The memory 904 may be a volatile or non-volatile memory used for storing data, metadata, and programs for execution by the processor(s). The storage device 906 includes storage, such as a hard disk, flash disk drive, or other digital storage device, for storing data or instructions for performing the methods described herein.

The I/O interface 908 allows a user to provide input to, receive output from, and otherwise transfer data to and receive data from computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example, and not by way of limitation, the communication interface 910 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 910 may facilitate communications with various types of wired or wireless networks. The communication interface 910 may also facilitate communications using various communication protocols. The communication infrastructure 912 may also include hardware, software, or both that couples components of the computing device 900 to each other. For example, the communication interface 910 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
determining, by at least one processor in connection with an object in a vector image, geometric parameters of a path of the vector image and a distance from the object to the path;
generating, by the at least one processor and for display via a graphical user interface displaying the vector image, a visual indicator of the geometric parameters of the path or the distance from the object to the path; and
modifying, by the at least one processor in response to an input via the graphical user interface, a rotation or a position of the object according to the geometric parameters of the path or the distance from the object to the path.

2. The computer-implemented method of claim 1, wherein generating the visual indicator of the geometric parameters of the path comprises generating an indication of a tangent or a normal of a point of the path based on the position of the object.

3. The computer-implemented method of claim 2, wherein modifying the rotation or the position of the object further comprises:
determining an initial angular offset between a portion of the object and the tangent or the normal of the point of the path; and
rotating, in response to the input via the graphical user interface, the object to maintain the initial angular offset between the portion of the object and the tangent or the normal of the path as the position of the object changes in the vector image.

4. The computer-implemented method of claim 1, wherein modifying the rotation or the position of the object further comprises:
determining an initial linear offset between a portion of the object and the path based on the distance from the object to the path; and
modifying the position of the object in the vector image to maintain the initial linear offset between the portion of the object and the path.

5. The computer-implemented method of claim 4, further comprising generating, for display via the graphical user interface, a visual indication of the initial linear offset as the position of the object changes.

6. The computer-implemented method of claim 1, wherein modifying the rotation or the position of the object comprises:
determining that the input via the graphical user interface comprises an input modifier; and
modifying, in response to the input modifier, the rotation or the position of the object according to the geometric parameters of the path or the distance from the object to the path.

7. The computer-implemented method of claim 1, further comprising:
providing, for display via the graphical user interface, a slider element that controls a translation of the object along the path; and
modifying the position of the object along the path in response to the input via the graphical user interface modifying the slider element.

8. The computer-implemented method of claim 1, further comprising:
determining a plurality of candidate paths of the vector image within a viewport of the graphical user interface; and
selecting the path from the plurality of candidate paths in response to determining that the path is closest to the object.

9. A system comprising:
one or more memory devices comprising a vector image; and
one or more processors configured to cause the system to:
determine, in response to a selection of an object in the vector image, one or more candidate paths of the vector image within a viewport of a graphical user interface displaying the vector image;
determine geometric parameters of a selected path of the one or more candidate paths and a distance from the object to the selected path; and
modify, in response to an input via the graphical user interface, a rotation or a position of the object according to the geometric parameters of the selected path or the distance from the object to the selected path.

10. The system of claim 9, wherein the one or more processors are further configured to cause the system to:
determine the one or more candidate paths further by generating a ranked list including the one or more candidate paths in order based on a distance of the one or more candidate paths to the object; and
determine the selected path by selecting a path with a highest ranking from the ranked list.

11. The system of claim 9, wherein the one or more processors are further configured to cause the system to determine the geometric parameters of the selected path further by:
determining an initial linear offset based on the distance from a center of the object to the selected path; and
determining an initial angular offset between the object and the selected path based on the geometric parameters of the selected path and an orientation extracted from metadata of the object.

12. The system of claim 11, wherein the one or more processors are further configured to modify the rotation or the position of the object by rotating, in response to the input changing the position of the object within the vector image, the object to maintain the initial angular offset between the orientation of the object and the selected path.

13. The system of claim 11, wherein the one or more processors are further configured to modify the rotation or the position of the object by translating the object along the selected path while maintaining the initial linear offset between the center of the object and points of the selected path nearest to the center of the object.

14. The system of claim 9, wherein the one or more processors are further configured to determine the geometric parameters of the selected path by:
determining, from the selected path, a point closest to the object; and
determining a tangent and a normal of the point closest to the object.

15. A non-transitory computer readable medium storing instructions thereon that, when executed by at least one processor, cause the at least one processor to perform operations comprising:
determining, for an object in a vector image, one or more candidate paths of the vector image;
determining geometric parameters of a selected path of the one or more candidate paths and a distance from the object to the selected path;
generating, for display via a graphical user interface displaying the vector image, a visual indicator of the geometric parameters of the selected path or the distance from the object to the selected path; and
modifying, in response to an input via the graphical user interface, a rotation or a position of the object according to the geometric parameters of the selected path or the distance from the object to the selected path.

16. The non-transitory computer readable medium of claim 15, wherein determining the one or more candidate paths further comprises:
determining, in response to the input comprising a rotation of the object, the one or more candidate paths of the vector image within a viewport of the graphical user interface;
generating a ranked list of the one or more candidate paths based on distances between a center of the object and nearest points of the one or more candidate paths; and
determining that the selected path is closest to the center of the object from the ranked list of the one or more candidate paths.

17. The non-transitory computer readable medium of claim 15, wherein determining the geometric parameters of the selected path further comprises:
determining a tangent and a normal of a point of the selected path;
determining an initial angular offset between a portion of the object and the tangent or the normal of the point of the selected path; and
determining an initial linear offset between a center of the object and the selected path, the initial linear offset corresponding to the distance from the object to the selected path.

18. The non-transitory computer readable medium of claim 17, wherein modifying the rotation or the position of the object further comprises:
determining that the input comprises a translation of the object;
determining a nearest point of the selected path based on the center of the object; and
modifying the rotation of the object to maintain the initial angular offset for the object relative to an additional tangent or an additional normal of the nearest point of the selected path utilizing a translation matrix.

19. The non-transitory computer readable medium of claim 18, wherein modifying the rotation or the position of the object further comprises modifying, in response to the translation of the object, the position of the object to maintain the initial linear offset for the object relative to the nearest point of the selected path.

20. The non-transitory computer readable medium of claim 15, wherein modifying the rotation or the position of the object further comprises:
determining a tangent and a normal of a point of the selected path; and
snapping an orientation of the object to the tangent or the normal of the point of the selected path in response to the input via the graphical user interface.
